(19) United States
(12) Patent Application Publication
(10) Pub. No.: US 2017/0058824 A1
(43) Pub. Date: Mar. 2, 2017

(54) PISTON WITH LOW OVERALL HEIGHT

(71) Applicant: KS KOLBENSCHMIDT GMBH, Neckarsulm (DE)

(72) Inventors: Eberhard Weiss, Langenbrettach (DE); Gerhard Luz, Nordheim (DE); Jochen Muller, Pfedelbach (DE); Emmerich Ottliczky, Forchtenberg (DE)

(21) Appl. No.: 14/844,617

(22) Filed: Sep. 3, 2015

(30) Foreign Application Priority Data
Aug. 28, 2015 (DE) DE102015216553.1

(51) Int. Cl. F02F 3/26; B23P 15/10; F02F 3/10; B23K 20/12; F02F 3/22; F02F 3/00

(52) U.S. Cl. CPC F02F 3/26; F02F 3/22; F02F 3/003; F02F 3/10; B23K 20/129; B23P 15/10; F02F 2003/0061; B23K 2201/003

(57) ABSTRACT

A piston for an internal combustion engine having an upper part joined by a positive material connection to a lower part, wherein the lower part includes a skirt and at least one pin bore, wherein the upper part includes a combustion bowl and a piston crown with a crown edge, wherein at least one joining point is located in the area of a ring belt and/or in an outer wall of the combustion bowl. A method for producing a piston for internal combustion engines is disclosed.

### BACKGROUND

The disclosure relates to a piston with low overall height for internal combustion engines and a method for producing the piston.

WO 2014/159634 discloses a finished piston component that is used to form a piston array. A finished piston has a lower part, wherein the lower part has a skirt and contains a lower surface of a cooling gallery. The lower part includes a radial dish-shaped inner surface. The finished piston array further has an upper part with a radial outer dish-shaped surface that can be joined to the radial inner dish-shaped surface. The upper part has a radial circumferential inner wall that includes a radial inner surface. The radial inner wall has a radial inward facing surface that forms a non-parallel angle to the radial inner dish surface in the area where the radial inner dish surface meets a radial innermost edge of the radial inner connecting surface.

In the case of pistons for internal combustion engines, what is known as the compression height corresponds to the distance between the axis of the piston pin and an upper edge of the piston. The overall height of an internal combustion engine is determined, among other factors, by this compression height of the internal combustion engine piston. A further characteristic parameter of an internal combustion engine piston that affects the overall height of the internal combustion engine is what is known as the bowl depth of a combustion bowl formed in the area of the piston upper part. Using relatively deep combustion bowls, combustion in the cylinder of the internal combustion engine in which the piston is employed can be improved. The deeper a combustion bowl is designed, however, the higher the compression height becomes and thus the overall height of the internal combustion engine. Furthermore, even with pistons having a low overall height, ingress and egress of the mixture, or of the gas, has to be ensured.

It would be desirable, therefore, to prepare a piston, specifically a cooling gallery piston, that, in comparison with known pistons of low overall height, enables improved mixture, or gas, exchange and a method for producing the piston.

### SUMMARY

A piston for an internal combustion engine is provided having an upper part connected in a positive material bond to a lower part, wherein the lower part comprises a skirt and at least one piston pin bore, wherein the upper part includes a combustion bowl and a piston crown with a crown edge, wherein at least one joining point is located in the area of a ring belt and/or in an outer wall of the combustion bowl. As a result, the joining point lies in areas of the positively materially bonded piston that require reworking. Thus, weld beads can be removed as part of this reworking to form the ring zone and/or the combustion bowl. A separate production step is not required.

Provision is further made for the position of the inner joining point to be in the outer wall of the combustion bowl above the finish machined combustion bowl base. In this way the inner friction weld bead is removed during the production of the combustion bowl. An additional production step is not required.

Provision is further made for the piston to have a low compression height, wherein the ratio of piston compression height and diameter of the piston lies between 0.48 and 0.75. The resulting piston enables optimized overall height for the intended internal combustion engine. This in turn reduces the installation space required by the internal combustion engine in motor vehicles, for example. The piston enables the production of mass-optimized internal combustion engines. Using pistons that have a low compression height, with a ratio of piston compression height to piston diameter between 0.48 and 0.75 can save material in production of the piston and in production of the internal combustion engine and, as a result, fuel consumption can in turn be reduced. With the optimized overall height of the internal combustion engine and the resulting reduced installation space for the internal combustion engine, new vehicle designs can emerge in turn. For example, wind resistance can be reduced in vehicles having an internal combustion engine using such pistons.

Provision is further made for there to be at least one recess in the piston crown. The danger of moving parts colliding inside the cylinder is reduced by the at least one recess. For example, a valve can penetrate the area of the recess without coming into contact with the piston having the at least one recess. Furthermore, the cylinder head can have internal contours that correspond to the at least one recess. As a result, contact with rigid parts inside the cylinder is prevented by the at least one recess in the piston. The contours in the cylinder head can, for example, serve to conduct the mixture, or the gas, into or out of the combustion chamber.

Provision is further made for the at least one recess to have at least one opening that at least partially passes through the edge of the piston crown. Maximum travel for the piston in the cylinder is possible as a result of the opening. The piston can approach the cylinder head in the area of the openings without running the risk of coming into contact with the valves. The mixture can enter the combustion chamber without hindrance. After combustion, the largely gaseous mixture can leave the combustion chamber with the piston in close proximity to the cylinder head.

Provision is further made for the at least one opening to be shaped as a segment of circle. As a result a connection is created from the opening to the cylinder wall. The opening assumes the form of a cylinder in its external shape.

Provision is further made for the at least one recess to form at least one valve pocket. A valve pocket allows an open valve to be accommodated in the area of the cylinder head when the piston approaches top dead center. It is hereby ensured that a piston having a low overall height can cover the longest possible travel inside the cylinder. The power stroke can thus be maximized with low overall height. The energy obtained from combustion can be converted efficiently into kinetic energy.

Provision is further made for the distance between a line, the line between pressure side and counter-pressure side, and the center of the first valve pocket to be greater than the distance between the line and the second valve pocket. This allows the valve pockets to be positioned predominantly in one half of the piston crown, when observed in a plan view. It is furthermore ensured that sufficient material remains between the recesses, or valve pockets so as not to weaken the piston crown.

Provision is further made for the distance between a line, the line between pressure side and counter-pressure side, and the center of the first valve pocket to be at least twice as large as the distance between the line and the center of the second valve pocket. This ensures that sufficient space exists between the valve pockets. Sufficient material remains to ensure safe operation of the internal combustion engine.

Provision is further made for the piston skirt to have a coating to reduce friction. As a result, the friction between the cylinder wall and the piston, already reduced due to the construction of the piston of low overall height, is diminished further. The benefits of this coating are great durability, outstanding sliding properties and a significant increase in the service life of the piston. The film thickness of the coating is, for example, about 0.01 mm. The film thickness of the coating can lie between 0.005 mm and 0.1 mm.

Provision is further made for the piston to have a cooling gallery. The result is effective dissipation of the heat resulting from combustion of a flammable mixture.

Provision is further made for there to be an extended feed to admit oil to the cooling gallery. Oil is intended as the cooling medium. An extended feed can hold a greater volume of in reserve oil in the cooling gallery. A reservoir for the cooling oil is created during operation of the internal combustion engine. The variation in the length of the feed can affect the level of the cooling oil in the reservoir.

Provision is further made for the contour of the cooling gallery to have molded-in recesses. The oil, or cooling oil, can come closer to the wall of the combustion bowl by means of these recesses. Heat exchange between combustion bowl and oil is improved. For example, the passage of heat from the combustion bowl to the cooling oil in the cooling gallery is accelerated.

Provision is further made for the molded-in recesses in the cooling gallery to correspond to the impact point of the detonation waves in the combustion bowl. With this arrangement of the recesses in the cooling gallery, direct transfer of the heat introduced into the combustion bowl by the detonation waves is made possible through the wall of the combustion bowl to the oil. The heat is dissipated close to its site of origin. The piston is not heated unnecessarily. The service life of the piston is increased as a result, and the probability of failure for the internal combustion engine having at least one such piston is consequently reduced.

Provision is further made for the upper part of the piston to be designed as a semi-hot forged upper part. Operations in semi-hot forging are performed primarily in the temperature range between 650 to 900° C. Flow stress is reduced in this range by more than one half for most types of steel compared with cold forming. The respective appropriate temperature depends on the type of steel, the size of the piston and the number of forming stages and is determined specifically for the piston. Because of the reduced volume and higher investment costs in machines and tools, the same piston of the same material produced semi-hot is somewhat more expensive than when cold-formed. More cost-effective production of the piston compared with cold-forming can be achieved through semi-hot forming by economizing on pressing procedures with costly intermediate treatment (intermediate annealing procedures, surface coating). Pistons formed to near-net shape or net-shape or economizing on heat treatment costs make cost-effective piston production possible using semi-hot forming. Pistons, or piston parts, are particularly suited to precision forming in the semi-hot range.

A method for producing a piston for an internal combustion engine is provided, having an upper part positively materially bonded to a lower part, wherein the lower part includes a skirt and at least one piston pin bore, wherein the upper part includes a combustion bowl and a piston crown with a crown edge, wherein the lower part and the upper part are joined by friction welding when the array is in position. As the result of the lower part and the upper part being joined by friction welding when the array is in position, positioning the array of lower part and upper part before friction welding is carried out ensures that the piston parts are always correctly positioned to each other when joined. There is no waste, or almost none, from the joining process.

Provision is further made for an inner friction welding bead to be removed during production of the combustion bowl. The resulting benefit is that no separate removal of the friction welding bead is performed. The procedural step to remove the friction welding bead is thus redundant. Consequently, the manufacturing costs for such a piston are reduced.

Provision is made in one embodiment for the dimensions of the finished piston to be selected such that the ratio of piston compression height KH and piston diameter DK is ≦0.53. Piston compression height KH is measured from the top side of the piston facing the combustion chamber to the center axis of the piston pin. The piston diameter DK is the outside diameter of the piston when ready for operation. Ready for operation means that the piston is finish machined after manufacture and can be installed in the cylinder of the engine. The outside diameter can be the diameter of the top land of the piston. Alternatively, the outside diameter of the piston can also be measured in the area of a land between two piston rings. If necessary, reference can be made to the diameter of a cylindrical or partially cylindrical piston skirt to determine the outside diameter of the piston.

The ratio of piston compression height to outside diameter of the piston ≦0.53 has the benefit of particularly compact piston construction, combined with low overall height and adequate strength to be able to satisfy requirements during operation in the cylinder of an internal combustion engine.

The use of a steel material in combination with the dimensions of the piston optimizes the properties of the array during operation of internal combustion engines. The steel material provides particularly good strength as well as mechanical and thermal resilience for the piston. The dimensions bring about a clear reduction in compression height and a reduction in mass, compared with aluminum pistons, of 10% and more, for example. The moving mass in the array is reduced. At the same time, the dimensioning of the piston pin in relation to piston diameter represents a very good compromise between the mass of the piston pin and the effective transmission of force from the piston into the piston pin when the internal combustion engine is operating. The reduced mass of the piston pin further contributes noticeably to reduction of the moving mass in the array under the invention. Reduction of overall height, or compression height, ultimately leads to lengthening the connecting rod which results in lower lateral forces and thus reduced frictional forces at the piston skirt, or between piston and cylinder bore surface.

Pistons with different combustion bowl shapes are employed in internal combustion engines. The piston under discussion has a dish-shaped combustion bowl. The piston crown is shaped such that squish flow in the radial direction is created between piston edge and cylinder head. In addition, swirl flow in the dish-shaped bowl is intensified. Pistons with dish-shaped combustion bowls are extremely suitable for internal combustion engines with swirl intake tracts and pre-chamber spark plugs. The mixture is displaced into the dish-shaped combustion bowl via the piston crown edge (squish edge) during the compression stroke. The mixture is drawn out of the dish-shaped combustion bowl again during the expansion stroke. This process results in strong squish flow, particularly in the proximity of top dead center. Supplemental to the squish flow, the dish-shaped combustion bowl causes the swirl flow generated on the intake side to accelerate. Because of the conservation of angular momentum, the rotational velocity of the swirl flow increases when the mixture is displaced inwards into the dish-shaped combustion bowl. The generation of squish flow and the intensification of swirl flow have a positive effect on combustion. Recesses in the piston crown that extend into the crown edge enable improved inflow of the mixture across the valves into the combustion chamber because the piston crown does not impede the inflow.

As part of reductions in fuel consumption and emissions in internal combustion engines configured as reciprocating piston engines, advancing developments lead to constantly increasing specific outputs in reciprocating piston engines. Accompanying this are smaller combustion chambers, specifically cylinders, in reciprocating piston engines that increasingly limit valve lift in the region of top dead center of pistons in reciprocating piston internal combustion engines to handle gas charge cycles. In order to limit these restrictions on the lift of both intake and exhaust valves, a piston for a reciprocating piston engine, with a ratio of piston compression height to outside diameter of the piston of 0.48 to 0.75, specifically ≦0.53, has at least one recess on the top facing side corresponding to an outer contour of a valve head for the reciprocating piston engine described as a valve pocket in which the valve head can be accommodated at least partially. Against the backdrop of constantly increasing peak pressures of a reciprocating piston engine of this type in combination with temperature fluctuations during operation of said combustion engine, severe demands are placed on the piston.

In accordance with another aspect, an internal combustion engine with at least one piston, as previously described, is prepared. This piston can be used in any type of reciprocating piston internal combustion engine. The more cylinders and pistons an internal combustion engine of this type comprises, the greater the effect achieved by the invention because piston skirt friction contributes a greater share of total friction.

In accordance with a further aspect, a vehicle is prepared with one of the previously described internal combustion engines. A vehicle of this type can be designed as a surface vehicle, as a watercraft or as an airplane. The most frequent version will relate to surface vehicles, for example, passenger cars, commercial vehicles or trucks.

A further advantage of low overall height is that the internal combustion engine in which the piston is operated can be built lower. Combined with the formation of recesses in the piston crown, an ever lower overall height for pistons can be achieved.

### BRIEF DESCRIPTION OF THE DRAWINGS

The basic idea is explained in what follows using the Figures. Additional details are described in the Figures using schematically represented embodiments as examples in which:

FIG. 1 shows a sectioned view of a piston;

FIG. 2 shows a sectioned view of a piston along the line II in FIG. 1;

FIG. 3 shows a detail identified in FIG. 2 with III;

FIG. 4 shows a detail from FIG. 2 identified with IV;

FIG. 5 shows a sectioned view of a piston along the line V-V in FIG. 2;

FIG. 6 shows a sectioned view of a piston along the line VI-VI in FIG. 2;

FIG. 8 shows a sectioned view of a piston area along the line VIII-VIII in FIG. 7;

FIG. 9 shows a plan view of a piston crown;

FIG. 10 shows a section from the piston in the area of a valve pocket provided on the piston crown side corresponding to a section taken along X-X in FIG. 9,

FIG. 11 shows a sectioned view of an additional piston,

FIGS. 12A and 12B show sectioned views of a lower part and an upper part of a piston from FIG. 11; and

FIGS. 13A and 13B show sectioned views of a lower part and an upper part of a piston from FIG. 11 rotated by 90 degrees compared with FIGS. 12A and 12B.

### DETAILED DESCRIPTION

In the following description of the Figures, terms such as top, bottom, above, below, left, right, front, back, etc. refer solely to the representation and position of the devices chosen as an example in the respective Figures and other elements. These terms are not to be understood in a restrictive sense, that is to say, these references may change as the result of different positions and/or mirror-image layout or similar.

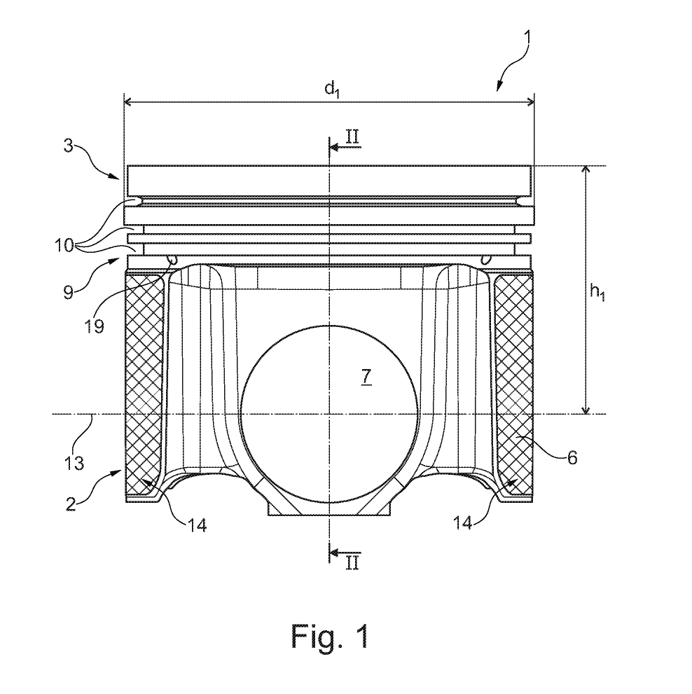

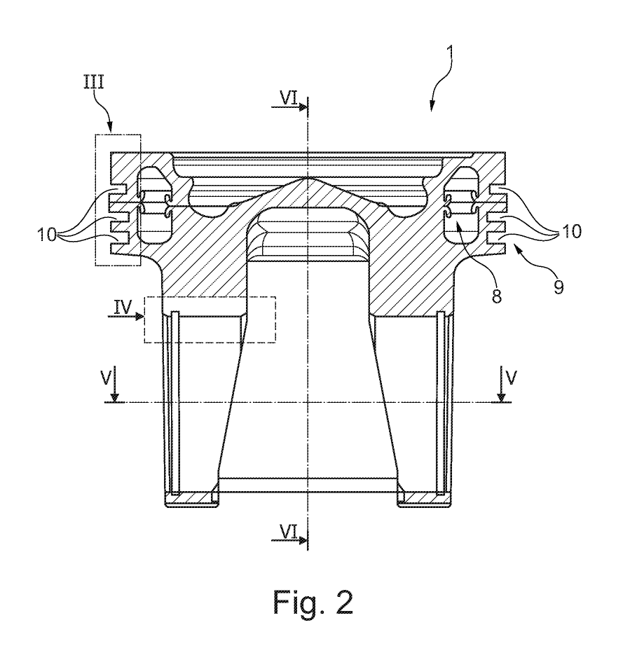

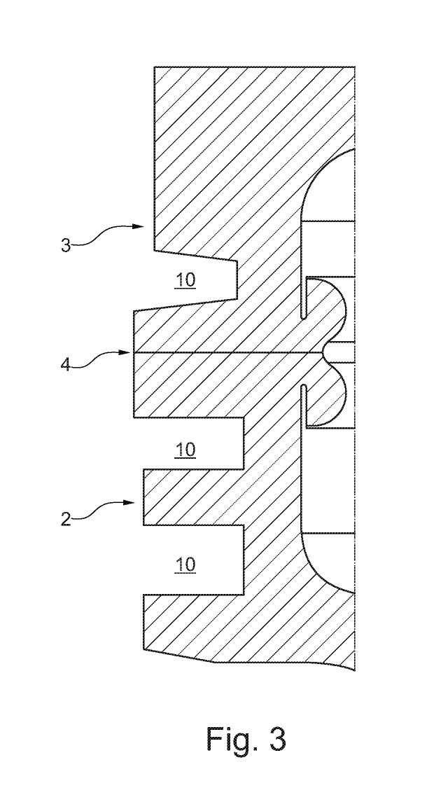

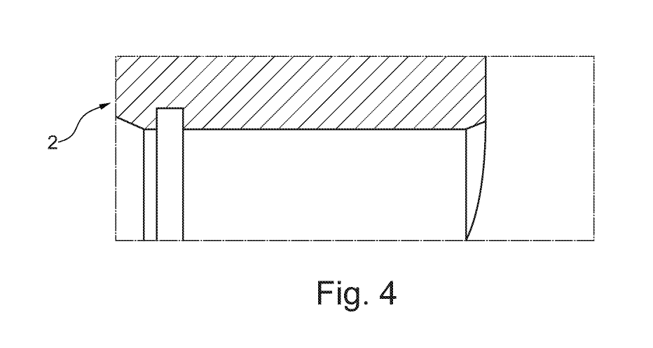

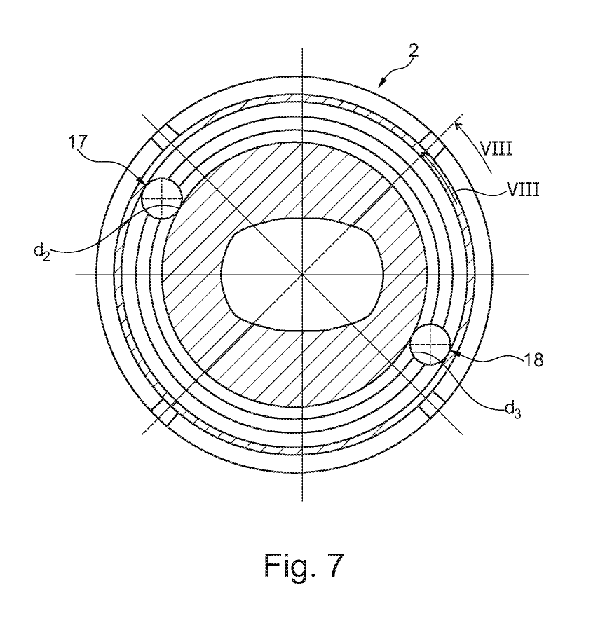

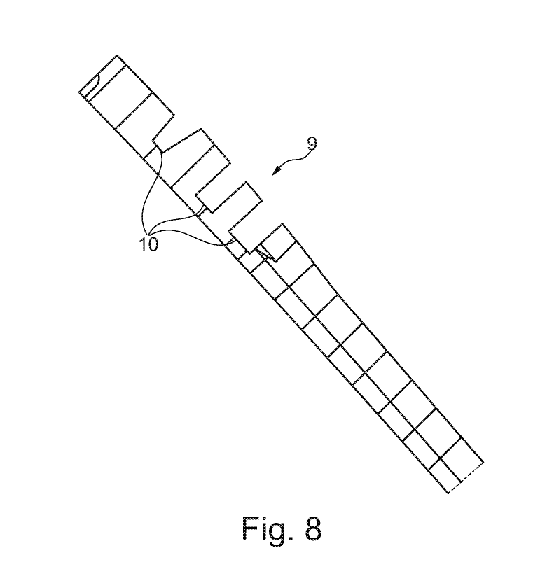

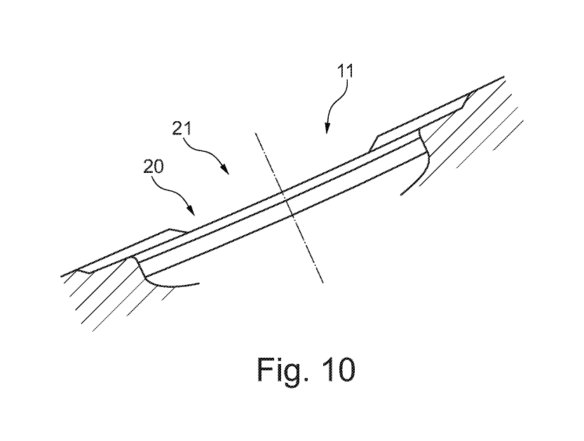

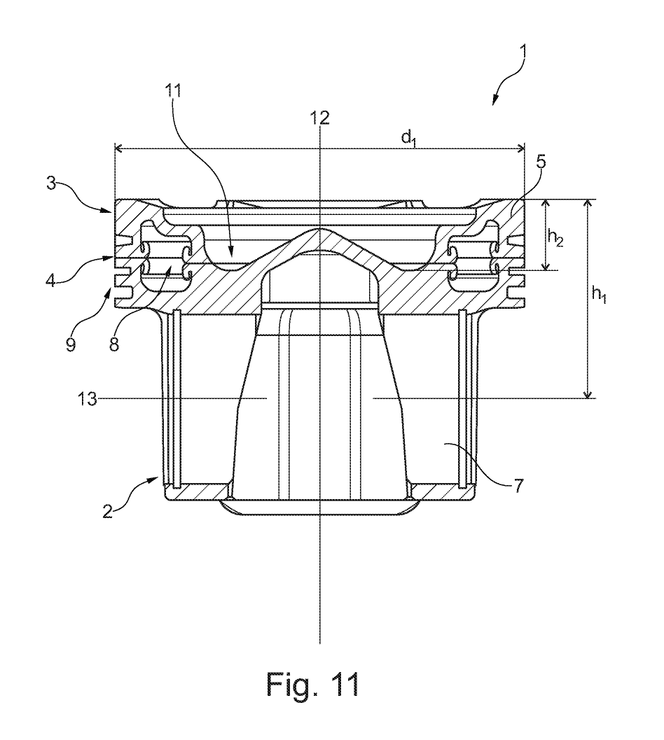

A section from a piston 1, or a piston 1 for an internal combustion engine, is shown in FIGS. 1, 2, 3, 4, 5, 6, 7, 8, 9 and 10. A further piston 1 for an internal combustion engine is shown in FIGS. 11, 12A, 12B, 13A and 13B. The piston 1 is constructed identically in the Figures in each case and is described generally at first in what follows. Then the Figures are presented in detail in each instance. Identical components are identified with the same reference numerals, and new reference numerals are used for different components in the Figures.

The piston 1 for an internal combustion engine in the Figures is produced from a lower part 2 and an upper part 3. At least one joining point 4 is formed between the lower part 2 and the upper part 3. Formed joining surfaces meet in the area of the joining point 4 on lower part 2 and upper part 3. One joining point can be formed in the region of a ring belt 9. Alternatively or supplementally, one joining point 4 can be formed in the outer wall of a combustion bowl 11. The at least one joining point 4 can be carried out as “pipe to plate”. As long as the piston 1 has at least one cooling gallery 6, the contour of the at least one cooling gallery 6 can be formed in the lower part 2 or the upper part 3, wherein this version is described as “pipe”. The matching side is executed as a circumferential, plane or almost plane, surface in the lower part 2 or the upper part 3 and correspondingly described as “plate”.

A piston crown 5 is configured on the upper part 3. The piston crown 5 is located on the side of the upper part 3 facing away from a cooling gallery 8. A piston skirt 6 is formed on the lower part 2 having piston pin bores 7. The piston 1, joined together from lower part 2 and upper part 3, has a circumferential ring belt 9, furnished with ring grooves 10. The combustion bowl 11 is located in the upper part 3, centrically or eccentrically around a piston stroke axis 12. A piston pin bore axis 13 is located in the region of the piston pin 7, corresponding to the center axis of the piston pin (not shown). Oil return orifices are located in the area of the ring belt 9.

A piston 1 joined from lower part 2 and upper part 3 is shown in FIG. 1. The piston has a coating 14 in the area of the skirt 6. The coating 14 demonstrates reduced friction. The benefits of this coating 14 are extremely high durability, outstanding sliding properties and a significant increase in the service life of the piston 1. The film thickness of the coating 14 is, for example, about 0.01 mm. The film thickness of the coating 14 can lie between 0.005 mm and 0.1 mm.

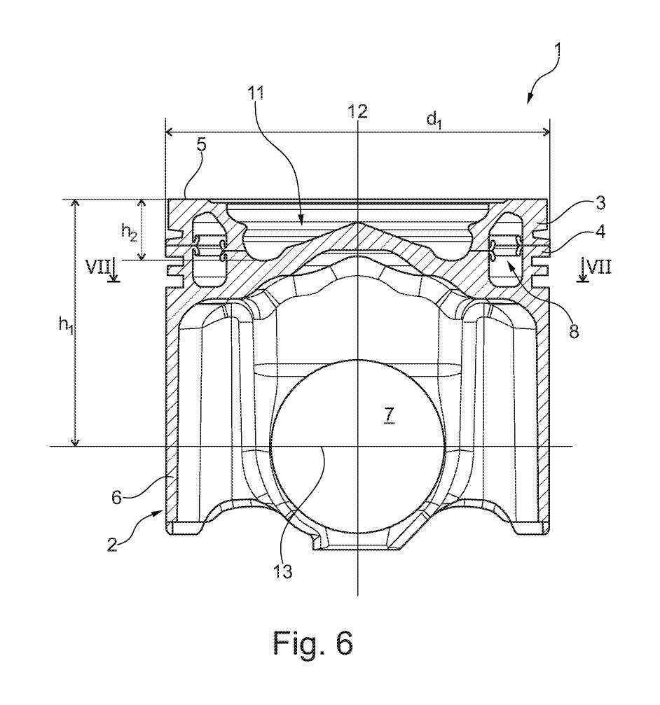

FIGS. 1, 6 and 11 show at which points piston compression height h₁ and the diameter of the piston d₁ are measured. Bowl depth of the combustion bowl h₂ is shown in FIGS. 6 and 11 in addition. Compression height h₁ can be 83 mm, for example, in FIGS. 1 and 6. The diameter d₁ of the piston 1 according to FIGS. 1 and 6 can be 130 mm, for example. The result is a ratio of compression height h₁ of the piston 1 to diameter d₁ of the piston 1 of 0.63. The value for h₁ can vary between 70 mm and 90 mm, preferably lying between 80 mm and 85 mm. The value for d₁ can lie between 120 mm and 145 mm, d₁ preferably lying between 125 mm and 135 mm. Thus the ratio of compression height h₁ to diameter d₁ of the piston 1 varies between 0.48 and 0.75.

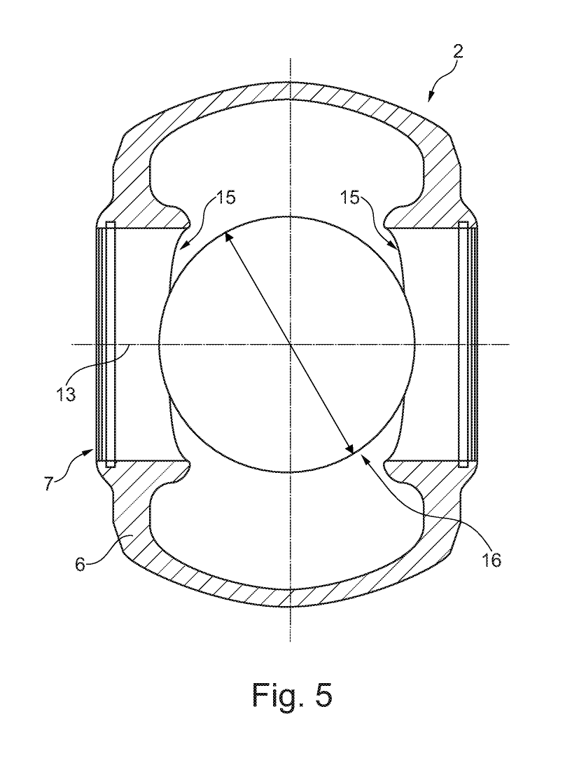

FIG. 5 shows a burr-free area 15 located in the area of pin bore 7. A supplementary locator 16 is shown in the center in addition.

FIG. 7 shows a feed 17 with a diameter d₂ and a return 18 with a diameter d₃. Oil can enter the cooling area through the feed 17 and can leave this area again through the return 18.

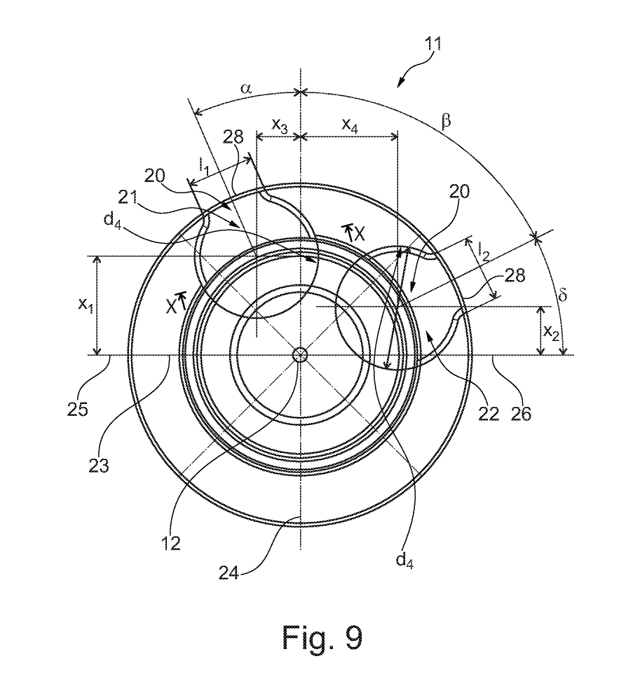

FIG. 9 shows two recesses 20, configured as valve pockets 21, 22, each having a diameter d₄. This diameter d₄ can be, for example, 47 mm. The diameter d₄ can assume a value between 35 mm and 55 mm, preferably between 40 mm and 50 mm. The diameter d₄ of the valve pockets 21, 22 can also assume different values. Any number of recesses 20, shaped as milled [slots] for example, can be provided. At least one part of the recesses 20 is shaped at least partially as a valve pocket in which gas exchange valves of the reciprocating piston internal combustion engine are accommodated at least partially when they are operating, that is to say, the exchange valves can protrude into the recesses 20. In this way a collision between the gas exchange valves and the piston 1 can be prevented. This design and function of the recesses 20, represents a functional integration that holds down the cost of the piston 1, specifically its manufacturing cost.

The valve pockets 21, 22 of the piston 1 adjoin the piston 1 in a radial direction, in which the respective, corresponding valve heads of gas exchange valves of the reciprocating piston internal combustion engine can be accommodated. When the piston 1 is at top dead center in the combustion chamber of the reciprocating piston engine, the valve pockets 21, 22 provide a sufficiently large clearance for the respective gas exchange valves, that is, for the corresponding intake and exhaust valves, so that the gas exchange valves can provide desirably large lift in each case to effect gas exchange. In other words, the gas exchange valves can open far enough due to the clearances provided by the valve pockets 21, 22 to efficiently effect an exchange of exhaust gas and air drawn in by the reciprocating piston internal combustion engine, or of a mixture drawn in by the reciprocating piston internal combustion engine.

A first segment of a circle K1 is located between a first valve pocket 21 and the line 24 standing perpendicular to the line 23 connecting a pressure side (DS) 25 and a counter-pressure side (GDS) 26. A second segment of a circle K2 is located between the line 24 standing perpendicular to the line 23 connecting a pressure side 25 and a counter-pressure side 26 and a second valve pocket 22. A third segment of a circle K3 is located between the second valve pocket 22 and the line 23 connecting the pressure side 25 and the counter-pressure side 26. The first segment of a circle K1 has, for example, a dimension of 23°. The first segment of a circle K1 can assume values between 15° and 30°, preferably between 20° and 25°. The second segment of a circle K2 has, for example, a dimension of 64°. The second segment of a circle can assume values between 55° and 70°, preferably between 60° and 65°. The third segment of a circle K3 has, for example, a dimension of 27°. The third segment of a circle K3 can assume values between 15° and 35°, preferably between 20° and 30°.

Around its circumference the piston crown l₁ is bounded by a crown edge 27. The edge of the crown 27 has recesses 28 shaped like the segment of a circle in the area of the valve pockets 21, 22. The length l₁ of the recess 28 of the first valve pocket 21 equals the length l₂ of the second valve pocket and is, for example, 25 mm. The lengths l₁ and l₂ can assume values between 15 mm and 35 mm, preferably between 20 mm and 30 mm. In accordance with the embodiment, l₁ and l₂ can have identical values, but do not have to have identical values. The dimensions for l₁ and l₂ can be varied independently of each other.

The distance x₁ between the line 23 and the center point of the first valve pocket 21 is greater than the distance x₂ between the line 23 and the center point of the second valve pocket 22. The distance x₁ is, for example, 37.3 mm. The distance x₂ is, for example, 18 mm. Thus the distance x₁ is at least twice as great as distance x₂. The distance x₁ can, lie between 30 mm and 45 mm, preferably between 35 mm and 40 mm. The distance x₂ can lie between 15 mm and 22.5 mm, preferably between 17.5 mm and 22.5 mm.

The distance between the center point of the first valve pocket 21 and the line 24 is identified with x₃. The distance between the line 24 and the center point of the second valve pocket is identified with x₄. The distance x₃ is shorter than the distance x₄. The distance x₄ is, for example, 36 mm, and the distance x₃ 15.7 mm. Thus the distance x₃ is at most half as long as distance x₄. The distance x₄ can lie between 25 mm and 45 mm, preferably between 30 mm and 40 mm. The distance x₃ can lie between 12.5 mm and 22.5 mm, preferably between 15 mm and 20 mm.

FIG. 11 shows a finished piston 1 from which it can be seen at which points the piston compression height h₁ and the diameter d₁ of the piston are measured. The piston 1 shown in FIG. 11 is a two-piece piston, consisting of upper part 3 and lower part 2, which are joined together. However, the piston 1 can also be configured in one piece. This piston 1 has a ratio between the compression height h₁ of the piston 1 and the diameter d₁ of the piston 1 of ≦0.53.

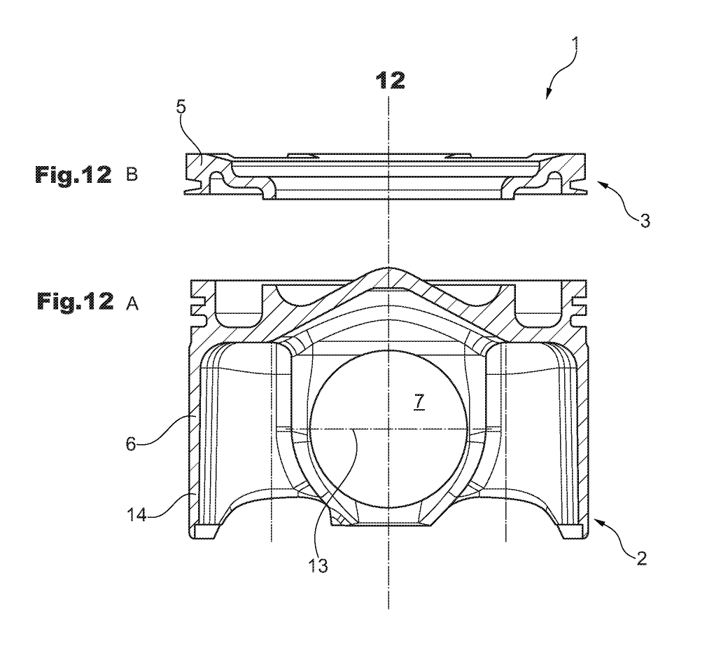

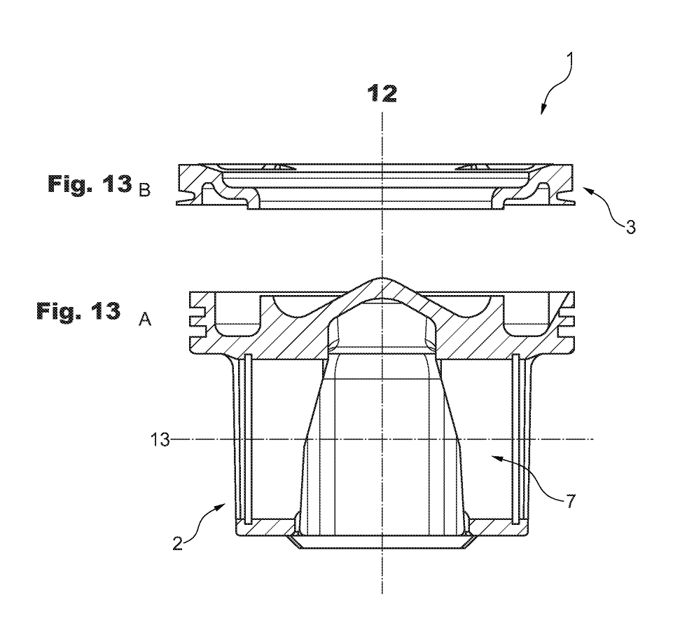

FIGS. 12A and 12B and 13A and 13B show views of upper part 3 and lower part 2 before they are joined. This is an example of a design configuration of upper part 3 and lower part 2 which are joined in a suitable manner, for example, by friction welding in order to achieve the desired ratio of ≦0.53.

What is claimed:

1. A piston for an internal combustion engine having an upper part joined through a positive material connection to a lower part, wherein the lower part includes a skirt and at least one piston pin bore, wherein the upper part includes a combustion chamber bowl and a piston crown with a crown edge, characterized in that at least one joining point is located in the area of a ring belt and/or in an outer wall of the combustion bowl.

2. The piston from claim 1, wherein a location of the inner joining point is provided in the outer wall of the combustion bowl above a finish-machined base of the combustion bowl.

3. The piston from the claim 1, wherein the piston has a low compression height, wherein the ratio of compression height (h₁) to piston diameter (d₁) is between 0.48 and 0.75.

4. The piston from claim 1, wherein at least one recess is provided in the crown of the piston.

5. The piston from claim 4, wherein the at least one recess has a least one opening that at least partially passes through the edge of the piston crown.

6. The piston from claim 5, wherein the at least one opening (28) is shaped as a segment of a circle.

7. The piston from claim 4, wherein the at least one recess forms at least one valve pocket.

8. The piston from claim 7, wherein a distance x₁ between a line, the line between pressure side and counter-pressure side, and a center point of the first valve pocket is greater than a distance x₂ between the line and the center point of the second valve pocket.

9. The piston from claim 8, wherein the distance x₁ between a line, the line between pressure side and counter-pressure side, and the center point of the first valve pocket is at least twice as large as the distance x₂ between the line and the center point of the second valve pocket.

10. The piston from claim 1, wherein the skirt of the piston has a coating to reduce friction.

11. The piston from claim 1, wherein the piston has a cooling gallery.

12. The piston from claim 11, wherein at least one extended feed is provided for oil access to the cooling gallery.

13. The piston from claim 12, wherein the cooling gallery has molded-in recesses in its contour.

14. The piston from claim 13, wherein the molded-in recesses in the cooling gallery correspond to a point where combustion waves impinge on the combustion bowl.

15. The piston from claim 1, wherein the upper part is configured as a semi-hot forged upper part.

16. A method for producing a piston for an internal combustion engine, having an upper part joined by a positive material connection to a lower part, wherein the lower part includes a skirt and at least one piston pin bore, wherein the upper part includes a combustion chamber bowl and a piston crown with a crown edge, characterized by joining the lower part and the upper part by friction welding with an array in position.

17. The method from claim 16, comprising removing an inner friction welding bead when the combustion bowl is produced.
